(19) United States
(12) Patent Application Publication
(10) Pub. No.: US 2016/0021912 A1
(43) Pub. Date: Jan. 28, 2016

(54) FROZEN CONFECTIONERY PRODUCT WITH IMPROVED STABILITY

(71) Applicants: Maud Isabelle Lallemand, Beauvals (FR); Virginie Marie Genevieve Des Champs De Boishebert, Bern (CH)

(72) Inventors: Maud Isabelle Lallemand, Beauvals (FR); Virginie Marie Genevieve Des Champs De Boishebert, Bern (CH)

(21) Appl. No.: 14/377,448

(22) PCT Filed: Feb. 5, 2013
(86) PCT No.: PCT/EP2013/052217

§ 371 Date: Aug. 7, 2014

(30) Foreign Application Priority Data
Feb. 8, 2012 (EP) 12154403.5

(51) Int. Cl. A23G 9/32; A23G 9/38

(52) U.S. Cl. CPC A23G 9/32; A23G 9/327; A23G 9/38

(57) ABSTRACT

A mainstream frozen confectionery product with natural emulsifier and stabiliser is the object of the invention. The product has low protein content, high overrun and an optimized ratio between fat and protein which provides an improved stability. A method for the manufacture of the frozen confectionery product as well as a process for improving the stability of mainstream ice cream with clean label is also described.

### FIELD OF INVENTION

The present invention relates to a “mainstream” frozen confectionary product essentially free from non-natural emulsifier or stabiliser, with an optimized fat:protein ratio. The present invention also relates to a method of manufacture for this frozen confectionary product and to the use of a specific ingredient mix to improve the stability of a mainstream, clean label frozen confection.

### BACKGROUND OF THE INVENTION

Cleaner or clean label products are becoming more and more popular among ice cream consumers. The demand is in particular directed to products that are free from artificial ingredients such as flavours, colours and emulsifiers, defined as “additives” or ingredients with so-called “E-numbers”.

While the replacement of artificial flavours and colours by natural ingredients may not have a major impact on the key attributes of the product, the functionality of stabilizers and emulsifiers is such that their replacement by natural ingredients is very challenging. In fact, those ingredients play an important role in terms of texture, scoopability, melting rate, heat shock resistance and shelf life of the frozen confectionary products.

The term “heat shock” as used herein, unless otherwise indicated, means the temperature fluctuations related to the storage and transportation of frozen confections. Heat shock can be simulated by treating a frozen ice cream product to temperature cycling of about-8 C to about-20° C. every 12 hours, with 30 min temperature ramp time for a period of about two weeks, or by any other method commonly used in the industry.

Efficient stabiliser compositions well known and widely used in any range of frozen confectionary products include ingredients, in particular emulsifiers, defined as “additives” or ingredients with so-called “E-numbers”. Examples of such additives often found in frozen confectionery formulations include mono- and diglycerides of fatty acids, esters of mono- and digylcerides of fatty acids, polyglycerol esters of fatty acids, polysorbates etc. They have certain drawbacks. These emulsifiers are in fact perceived as “non-natural” ingredients, deemed to be unhealthy in the eyes of the consumer. The presence of these ingredients in frozen confection recipes leads to reduced authenticity of the frozen confectionary products.

Natural emulsifiers are known but they are not as efficient as any known additives to stabilize frozen confections and their use has therefore been limited heretofore to products easier to stabilize such as “premium” or “super premium” products.

Such “premium” range of frozen confectioneries is usually characterised by a rather low overrun e.g. below 50%, high levels of fat and high levels of protein. Their total solid content is also usually above 40 wt %. The low overrun in these products provides them with a low thermal conductivity and therefore these products are less affected by heat shock. On the other hand, the high protein content usually compensates for the need of any “non natural” emulsifier. However the proteins being expensive, this solution is not suitable for standard or “mainstream” frozen confectionary products.

For example, EP 2025240 discloses a natural stabiliser system that can be used in the manufacture of natural frozen confectionary products. The stabiliser system of EP 2025240 comprises native rice starch and fibres from vegetables, fruits or mixtures thereof. Starch is a carbohydrate and the use of starch is a non traditional component of frozen confectionary products. EP 2025240 publication discloses frozen confectionary products which are aerated with an overrun of 20-80%, and products with a protein content higher than 3%. EP 2025240 publication fails to disclose solutions suitable for mainstream range.

Mainstream frozen confectionary products are usually characterised by an overrun above 80% and their content in protein is lower than that of “premium” frozen confectioneries, to make such products affordable to most consumers.

Providing mainstream frozen confectionary products using natural ingredients while not compromising on the product stability is a challenge. Premium ice creams are usually made with fat from a dairy source and contain little or no fat from a vegetable source. These frozen confectionary products are expensive to manufacture and thus costly to the consumer due to the high load of quality ingredients. These products can also be seen as unhealthy due to the high levels of fat and sugars.

There is a need to improve the stability and heat shock resistance of mainstream frozen confectionary products that are made with natural ingredients.

The invention provides a solution to the above-mentioned problems.

### SUMMARY OF INVENTION

In a first aspect, the invention relates to an aerated frozen confectionery product with an overrun of at least 80%, comprising from 4 to 14 wt % fat, less than 3 wt % protein, from 5 to 35 wt % of a sweetening agent and from 0 . to 3 wt %, preferably from 0.1 to 3 wt % of natural emulsifier and/or natural stabiliser, wherein the ratio between fat and protein is higher than 3.9. This product is essentially free from any non-natural emulsifier or stabilizer.

According to a second aspect, the invention relates to a process for the preparation of such a product, comprising the steps of:

a) providing an ingredient mix comprising.from 4 to 14 wt % fat, less than 3 wt % protein, from 5 to 35 wt % of a sweetening agent and from 0 to 3 wt %, preferably from 0.1 to 3 wt % of natural emulsifier and/or natural stabiliser, wherein the ratio between fat and protein is higher than 3.9;

b) pasteurizing and homogenizing the mix;

c) freezing while aerating the mix;

d) optionally hardening the mix.

The invention also relates to the use of an ingredient mix comprising from 4 to 14 wt % fat, less than 3 wt % protein, from 5 to 35 wt % of a sweetening agent and from 0 to 3 wt %, preferably from 0.1 to 3 wt % of natural emulsifier and/or natural stabiliser, wherein the ratio between fat and protein is higher than 3.9, for improving the stability of a frozen aerated confection essentially free from non-natural ingredients, as defined above.

For a complete understanding of the present invention and the advantages thereof, reference is made to the following detailed description of the invention. It should be appreciated that various aspects of the present invention are merely illustrative of the specific ways to make and use the present invention and do not limit the scope of the invention.

### BRIEF DESCRIPTION OF THE FIGURES

FIG. 1 shows the result of the melting test performed on the 3 products of Example 1, on fresh ice cream on the one hand, and on heat shocked ice cream on the other hand.

FIG. 2 shows the result of the melting test performed on the 3 products of Example 2, on fresh ice cream on the one hand, and on heat shocked ice cream on the other hand hand.

FIG. 3 shows the result of the melting test performed on the 3 products of Example 3, on fresh ice cream on the one hand, and on heat shocked ice cream on the other hand.

### DETAILED DESCRIPTION OF INVENTION

In the context of the invention, “natural ingredients” is meant to designate ingredients of natural origin. These include ingredients which come directly from the field, the animals etc. They may also include ingredients which are the result of a physical or microbiological/enzymatic process (e.g. filtering, drying, centrifugation, fermentation etc.). However, they do not include ingredients which are the result of a chemical modification process.

Unless otherwise specified, percentages are meant to designate percentages of dry matter by weight.

Frozen confectionery products include ice cream, mellorine, frozen yogurt, frozen beverage, milk shake, frozen mousse, frozen fudge, frozen custard and other frozen desserts.

The aeration or overrun in the context of the invention is produced by incorporation of gas into the confectionery product. The gas can be any food grade gas such as air, nitrogen, or carbon dioxide. The overrun is defined as follows: (Reference: Robert T. Marshall, Douglas Goff and Richard W. Hartel, 2003, Ice Cream—6th Edition, Ed. Kluwer Academic/Plenum Publishers (New York), ISBN 0-306-47700-9, page 144.)

$$\% overrun = \frac{wt of mix - wt of same vol . of ice cream}{wt of same vol . of ice cream} * 100$$

In a first aspect, the present invention relates to an aerated frozen confectionery product with an overrun of at least 80%, comprising from 4 to 14 wt % fat, less than 3 wt % protein, from 5 to 35 wt % of a sweetening agent and from 0 to 3 wt %, preferably from 0.1 to 3 wt % of natural stabilizer and/or natural emulsifier, wherein the ratio fat:protein is higher than 3.9.

While natural stabilizer and/or emulsifiers have been disclosed in the art, the applicant surprising found that a significant improvement in the stability of “mainstream” products comprising natural emulsifiers and/or natural stabilisers could be obtained with an optimized fat:protein ratio. Mainstream product designate in the context of the invention products with a minimum overrun of 80% and a protein content lower than 3%. This finding is even more surprising in view of the fact that proteins being known and having been widely used for their emulsifying properties, one could have thought that increasing the amount of protein would have improved the stability of the products. Unexpectedly, it is the reverse that has been observed, namely that at equal fat contents, lower amounts of proteins have shown to improve product stability.

The invention therefore presents the double advantage of offering the possibility to improve the stability of mainstream products (with high overrun and low in proteins), while reducing their costs by lowering the amount of proteins therein.

The product of the invention is first of all characterised by an overrun of at least 80% which is relatively high compared to premium or super-premium products. According to a particular embodiment, the overrun is higher than 100% and preferably it is comprised between 100 and 140%.

The product of the invention has a protein content which is limited to 3 wt %, and preferably lower than 2.7 wt %.

The proteins used in the present invention include in particular milk proteins, soy protein, pea protein, whey protein, barley protein, potato protein and lupin protein. The protein can be any one of the proteins or can be mixtures of the proteins. Preferably, whey protein and/or milk protein are used.

Fat is present in the products of the invention in an amount comprised between 4 wt % and 14 wt %, preferably between 6 wt % and 13 wt %, more preferably between 8 and 12 wt %. Fat can be from a dairy source, a vegetable source or mixtures thereof. Examples of fat include fresh cream, sour cream, cultured cream, butter, concentrated butter, cocoa butter, coconut oil, hazelnut oil, palm oil, palm kernel oil, rapeseed oil, soybean oil and sunflower oil.

The frozen products of the invention also include sugars as part of a sweetening agent. By “sweetening agent” is to be meant a mixture of ingredients which imparts sweetness to the final product. Suitable sweetening agents include sugar, glucose syrups, and natural sugars like cane sugar, beet sugar, molasses, other plant derived nutritive sweeteners and natural non-nutritive high intensity sweeteners.

In particular, the sugars used in the present invention include mono- and di-saccharides.

The product further comprises from 0 to 3 wt % of natural emulsifier and/or natural stabilizer.

Descriptions of “emulsifier” and “stabilizer” are given by Robert T. Marshall, Douglas Goff and Richard W. Hartel, 2003, in Ice Cream—6th Edition, Ed. Kluwer Academic/Plenum Publishers (New York), ISBN 0-306-47700-9, (Chapter 3, pages 80 to 86.)

According to one embodiment, the product of the invention is essentially free from any stabilizer or emulsifier. According to another embodiment, the product of the invention comprises from 0.1 to 3 wt % of a natural stabilizer and/or natural emulsifier.

The product of the invention does not make use of non-natural additive emulsifiers known in the art and is essentially free from any non-natural emulsifier or stabilizer. According to a particular embodiment, the product of the invention is essentially free from additives selected from the group consisting of mono- and diglycerides or fatty acids, sucrose esters of fatty acids, polyglycerol esters of fatty acids, polyglycerol polyricinoleate, polyethylene sorbitan mono-oleate, polysorbate 80, propylene glycol monostearate, chemically extracted lecithin and modified starch. According to another embodiment, the product is further essentially free from carrageenan and/or gelatine.

“Essentially free” as used here-in means that these materials are not intentionally added for their conventional properties imparting abilities, i.e. stabilizing, although there could be unintended minor amounts present without detracting from the performance of the products. Generally and preferably, the products of the invention will not contain any non-natural materials.

Examples of natural emulsifier that can be used in the context of the invention include egg yolk, buttermilk, rice bran extract or mixtures thereof.

Examples of natural stabilizer that can be used in the context of the invention include natural gums such as pectin, guar gum, locust bean gum, tara gum, xanthan gum, arabic gum, quillaia gum and agar or any mixtures thereof.

The invention present the advantage of performing, i.e. improving the stability of the product independently of the nature of the natural emulsifier or stabilizer, even when the product does not contain any of those.

According to a particular embodiment, the product of the invention does not comprise egg yolk.

According to another embodiment, the product of the invention does not contain starch.

According to another embodiment, the product of the invention does not contain any stabilizer.

The applicant has surprisingly found that with a fat:protein ratio above 3.9, the product according to the invention had an improved stability. Stability can in particular be revealed looking at the melting behavior of the product after a heat shock treatment. The melting behaviour of the products according to the invention subjected to heat shock is improved. Preferably, the ratio of fat:protein in the products according to the invention is above 4.5, more preferably above 5. Against all expectations, it has been found that ice cream without artificial emulsifier, was more stable when further reducing the amount of proteins.

In a further aspect, the invention relates to a method for the manufacture of the frozen confectionary product as defined above.

In a first step of the method, a frozen confectionary ingredient mix comprising from 4 to 14 wt % fat, less than 3 wt % protein, from 5 to 35 wt % of a sweetening agent and from 0 to 3 wt %, preferably from 0.1 to 3 wt % of natural emulsifier and/or natural stabiliser, wherein the ratio between fat and protein is higher than 3.9; are blended together to form a mix.

Following the formation of the mix, a pasteurisation step, and an homogenisation step are carried out on the mix. It is not important in which order the pasteurisation step and the homogenisation step are carried out.

The pasteurisation step is carried out under standard pasteurisation conditions as known in the art.

Homogenisation is preferably carried out under standard conditions, as known in the art, adapted to the fat in the formula, namely at a pressure of between 40 and 250 bars, preferably between 80 and 245 bars, more preferably between 100 and 240 bars.

The homogenised mix may then be cooled to around 2 to 8° C. by known means. The mix may further be aged for 4 to 72 h at around 2 to 6° C. with or without stirring. Optionally, the addition of flavourings, colourings, sauces, inclusions etc. may be carried out prior to the ageing step or during the freezing step. If flavourings, colourings, sauces, inclusions etc. are added, these are preferably selected from natural ingredients only.

In the next step, the mix is aerated. In a preferred embodiment, the mix may be cooled to a temperature below −3° C., preferably between −3 and −10° C., preferably at about −4.5 to −8° C. with stirring and injection of gas to creats the desired overrun.

The frozen confectionery is preferably aerated to an overrun of at least 80%, preferably between100% and 140%.

The aerated mix can be subjected to freezing either using conventional freezing equipment or by a low temperature extrusion system. In this equipment, the aerated mix is cooled by extrusion at a temperature of below −11° C., preferably between −12° C. and −18° C. in a screw extruder. The screw extruder may be such as that described in WO 2005/070225. The extrusion may be performed in a single or twin screw extruder.

The frozen mix is then packaged and stored at temperatures below −20° C., where it will optionally undergo hardening step during storage. Alternatively, it can be hardened by accelerated hardening step, for example via a hardening tunnel, carried out at a temperature between −20° C. to −40° C. for a sufficient time to harden the product.

According to a third aspect, the invention relates to the use of an ingredient mix comprising from 4 to 14 wt % fat, less than 3 wt % proteins, from 5 to 35 wt % of a sweetening agent and from 0 to 3 wt %, preferably from 0.1 to 3 wt % of natural stabilizer or emulsifier, wherein the ratio fat:protein is higher than 3.9; in the preparation of a natural aerated frozen confection, for improving the stability to that frozen confection.

The present invention is illustrated herein by reference to the following examples which should not be considered as limiting the invention.

### EXAMPLES

Tests:

Melting tests were carried on frozen confectionary products. The percentage of melted ice cream was measured according to the following formula:

$$\% meltedIceCream = \frac{{m}_{4} - {m}_{3}}{{m}_{1} - {m}_{2}} * 100$$

In which, ml is the mass of the frozen confectionary product with its package in grams; m2 is the mass of the package alone in grams, m3 is the mass of the container alone in grams and m4 is the mass of the container with the dripped product at a given time in grams. Results reported in examples show the % melted ice cream measured after 180 minutes at 22° C.

Heat Shock Test:

Heat shock stresses were applied to samples over 7 days and each heat shock cycle lasted for 24 hours with temperature variations of between −20° C. to −8° C.

Heat shocked: submitted to heat shock test stresses. Fresh: kept frozen, without temperature stress after production.

### Example 1

Aerated frozen confectionary products with natural stabilizer and natural emulsifier (egg yolk).

Three aerated frozen confections were prepared based on the following recipes:

TABLE 1a

| | Product Ref. | | |
|---|---|---|---|
| | 1 | 2 | 3 |
| | % dry matter | % dry matter | % dry matter |
| | by weight in | by weight in | by weight in |
| Ingredients | end product | end product | end product |
| Dairy cream | 10.4 | 10.4 | 14.0 |
| Skimmed milk and | 9.3 | 7.3 | 6.6 |
| sweet whey | | | |
| Sugars & glucose | 20.1 | 21.7 | 21.2 |
| syrups | | | |
| Natural emulsifier | 0.3 | 0.3 | 0.3 |
| (egg yolk) | | | |
| Natural stabilisers | 0.2 | 0.2 | 0.2 |
| (gums) | | | |
| Colors & flavoring | 0.2 | 0.2 | 0.2 |
| Total solids | 40.6 | 40.1 | 42.6 |
| Dairy Fat/Dairy prot | 3.3 | 4.7 | 6.3 |
| Dairy fat (from | 9 | 9 | 12 |
| cream) | | | |
| Dairy prot | 2.7 | 1.9 | 1.9 |

Method:

Conventional mix proceedings, homogenisation and pasteurization were used, as well as freezing in a continuous freezer.

In particular, following blending, the 3 mixes were homogenized at pressures according to Danisco Technical Memorandum TM 2001-1e, and then pasteurised using a continuous plate heat-exchanger (at 81 to 87° C. for 30 to 36 seconds). Mixes were aged from 18 to 32 hours, in chilled conditions. Each mix was frozen on a Hoyer KF 80 continuous freezer. An overrun of 105% was provided. Each ice cream was then hardened in a ventilated hardening cell at −30° C. to −40° C.

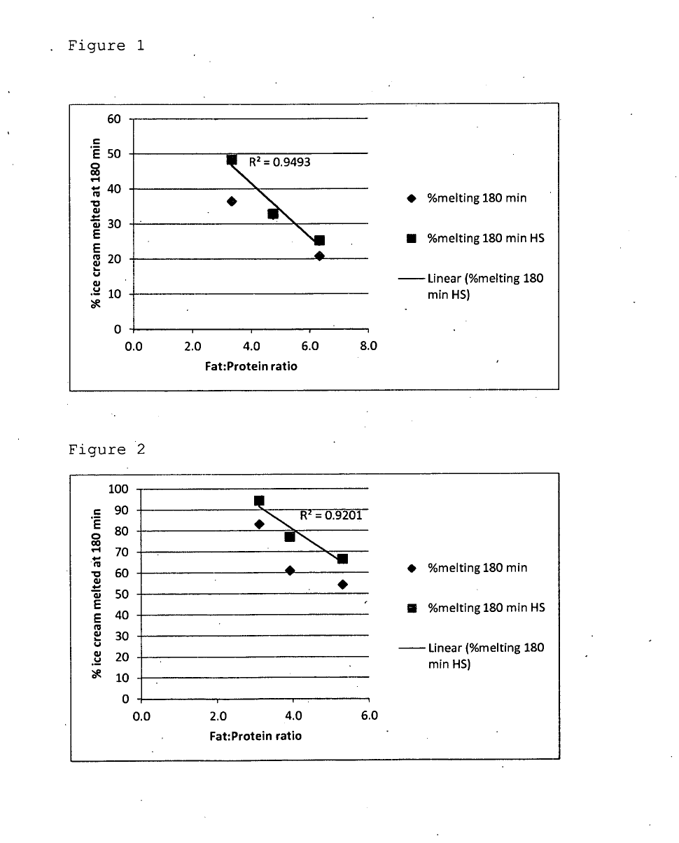

Melting test as described above was performed on the 3 products, with fresh ice cream on the one hand, and with heat shocked ice cream on the other hand. The results from Table 1b) are represented in FIG. 1.

TABLE 1b

| Product ref. | 1 | 2 | 3 |
|---|---|---|---|
| % melting 180 min | 36 | 33 | 21 |
| % melting 180 min HS* | 48 | 33 | 25 |

*Heat Shock

With increased fat:protein ratio, ice cream has better melting resistance, especially after heat shock. Two first points have same fat level; two last points have same protein level. Results for ratio above 3.9 are better than for ratio below 3.9.

### Example 2

Aerated frozen confectionary products with natural stabilizer, and no added emulsifier.

Three aerated frozen confections were prepared based on the following recipes:

TABLE 2a

| | Product ref. | | |
|---|---|---|---|
| | 1 | 2 | 3 |
| | % dry matter | % dry matter | % dry matter |
| | by weight in | by weight in | by weight in |
| Ingredients | end product | end product | end product |
| Dairy cream | 10.7 | 10.7 | 10.7 |
| Skimmed milk and | 10.7 | 8.1 | 5.5 |
| sweet whey | | | |
| Sugars & glucose | 19.2 | 21.7 | 24.2 |
| syrups | | | |
| emulsifier | 0.0 | 0.0 | 0.0 |
| natural stabilisers | 0.15 | 0.15 | 0.15 |
| (gums) | | | |
| colors | 0.008 | 0.008 | 0.008 |
| Total solids | 40.8 | 40.7 | 40.6 |
| Dairy Fat/Dairy prot | 3.1 | 3.9 | 5.3 |
| Dairy fat (from | 9 | 9 | 9 |
| cream) | | | |
| Dairy prot | 2.9 | 2.3 | 1.7 |

Method:

Conventional mix proceedings, homogenisation and pasteurization were used, as well as freezing in a continuous freezer.

In particular, following blending, the 3 mixes were homogenized at pressures according to Danisco Technical Memorandum TM 2001-1e, and then pasteurised using a continuous plate heat-exchanger (at 81 to 87° C. for 30 to 36 seconds). Mixes were aged from 18 to 32 hours, in chilled conditions. Each mix was frozen on a Hoyer KF 80 continuous freezer. An overrun of 105% was provided. Each ice cream was then hardened in a ventilated hardening cell at −30° C. to −40° C.

Melting test as described above was performed on the 3 products, with fresh ice cream on the one hand, and with heat shocked ice cream on the other hand. The results from Table 2b) are represented in FIG. 2.

TABLE 2b

| Product ref. | 1 | 2 | 3 |
|---|---|---|---|
| % melting 180 min | 83.1 | 61 | 54.3 |
| % melting 180 min HS* | 94.35 | 77.08 | 66.47 |

*Heat Shock

With increased fat:protein ratio, ice cream has better melting resistance after heat shock. With same fat content, similar effect of ratio increase at other fat % have been observed. Melting resistance decreases with ratio below 3.9. Above 3.9, the higher the ratio the better the melting resistance.

### Example 3

Aerated frozen confectionary products with natural stabilizers and natural emulsifier (egg yolk). Three aerated frozen confections were based on vegetable dil and were prepared based on the following recipes:

TABLE 3a

| | Product ref. | | |
|---|---|---|---|
| | 1 | 2 | 3 |
| | % dry matter | % dry matter | % dry matter |
| | by weight in | by weight in | by weight in |
| Ingredients | end product | end product | end product |
| Vegetable oil | 8.7 | 8.7 | 8.7 |
| Skimmed Milk & | 10 | 8.7 | 7.5 |
| sweet whey | | | |
| Sugars and glucose | 21.4 | 22.7 | 24 |
| syrups | | | |
| Natural Emulsifier | 0.4 | 0.4 | 0.4 |
| (egg yolk) | | | |
| Natural stabilizers | 0.2 | 0.2 | 0.2 |
| Colors & flavorings | 0.1 | 0.1 | 0.1 |
| Total solids | 40.8 | 40.8 | 40.9 |
| Fat from oil/Dairy prot | 3.78 | 4.35 | 5.12 |
| Fat content (from | 8.7 | 8.7 | 8.7 |
| oil) | | | |
| Dairy prot | 2.3 | 2 | 1.7 |

Method:

Conventional mix proceedings, homogenisation and pasteurization were used, as well as freezing in a continuous freezer.

In particular, following blending, the 3 mixes were homogenized at pressures according to Danisco Technical Memorandum TM 2001-1e, and then pasteurized using a continuous plate heat-exchanger (at 81 to 87° C. for 30 to 36 seconds). Mixes were aged from 18 to 32 hours, in chilled conditions. Each mix was frozen on a Hoyer KF 80 continuous freezer. An overrun of 105% was provided. Each ice cream was then hardened in a ventilated hardening cell at −30° C. to −40° C.

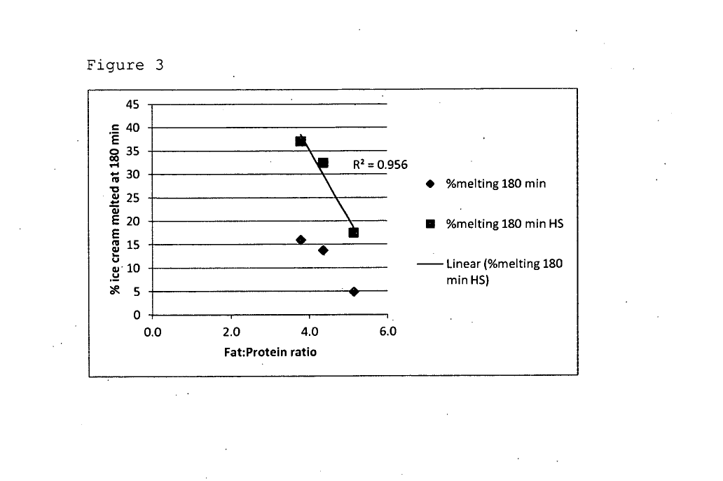

Melting test as described above was performed on the 3 products, with fresh ice cream on the one hand, and with heat shocked ice cream on the other hand. The results from table 3b) are represented in FIG. 3.

TABLE 3b

| Product ref | 1 | 2 | 3 |
|---|---|---|---|
| % melting 180 min. | 16.0 | 13.8 | 4.9 |
| % melting 180 min HS* | 37.1 | 32.5 | 17.5 |

*Heat Shock

With an increased fat:protein ratio, ice cream has a better melting resistance, especially after heat shock.

The three points have the same fat level but different proteins levels.

Results for ratio above 3.9 are better than for ratio below 3.9.

1. An aerated frozen confectionery product with an overrun of at least 80%, comprising from 4 to 14 wt % fat, less than 3 wt % protein, from 5 to 35 wt % of a sweetening agent and from 0 to 3 wt % of natural stabilizer and/or natural emulsifier; and the ratio of fat:protein in the product is greater than 3.9.

2. A product according to claim 1, wherein the product does not contain egg yolk.

3. A product according to claim 1, wherein the product does not contain any stabilizer.

4. A product according to claim 1, wherein the product does not contain starch.

5. A product according to claim 1, wherein the product is essentially free from additives selected from the group consisting of mono- and diglycerides of fatty acids, sucrose esters of fatty acids, polyglycerol esters of fatty acids, polyglycerol polyricinoleate, polyethylene sorbitan mono-oleate, polysorbate 80, chemically extracted lecithin and modified starch.

6. A product according to claim 1, wherein the product is essentially free from of carrageenan and/or gelatine.

7. A product according to claim 1, wherein the ratio of fat:protein is greater than 4.5.

8. A product according to claim 1, wherein the protein is present in an amount less than 2.7 wt %.

9. A product according to claim 1, wherein the overrun is between 100 and 180%.

10. A product according to claim 1, wherein the protein is of a milk origin.

11. A product according to claim 1, wherein the fat is selected from the group consisting of dairy and vegetable fats.

12. A process for the preparation of a product comprising the steps of:
providing an ingredient mix comprising from 4 to 14 wt % fat, less than 3 wt % protein, from 5 to 35 wt % of a sweetening agent and from 0 to 3 wt % of natural stabilizer and/or natural emulsifier, wherein the ratio of fat:protein is greater than 3.9;
pasteurizing and homogenising the mix; and
freezing while aerating the mix;

13. A process according to claim 12, wherein the freezing step is followed by a dynamic cooling of the mix to a temperature below −11° C. in an extruder.

14. A product obtainable by the method of claim 12.

15. A method for the preparation of a frozen confection comprising mixing from 4 to 14 wt % fat, less than 3 wt % protein, from 5 to 35 wt % of a sweetening agent and from 0 to 3% wt %, of natural stabilizer and/or natural emulsifier, wherein the ratio of fat:protein is greater than 3.9 to provide a frozen confection with improved stability.
